(19) United States
(12) Patent Application Publication
(10) Pub. No.: US 2008/0255865 A1
(43) Pub. Date: Oct. 16, 2008

(54) Using Relationships Between Master Data and Transactional Data to Process Business Documents

(75) Inventors: Gerd M. Ritter, Heidelberg (DE); Volkmar Stegmann, Altlussheim (DE); Matthias Schmitt, Speyer (DE); Toralf Grossmann, Wiesloch (DE); Axel Werner, Heidelberg (DE); Wolfram Bonheim, Muehlhausen (DE)

Correspondence Address: FISH & RICHARDSON, P.C., PO BOX 1022, MINNEAPOLIS, MN, 55440-1022, US

(73) Assignee: SAP AG

(21) Appl. No.: 11/735,739

(22) Filed: Apr. 16, 2007

(51) Int. Cl. G06Q 10/00

(52) U.S. Cl. 705/1

(57) ABSTRACT

In a computing system, an indication of a predefined transaction participant role in which a specified participant serves in a specified computer-implemented transaction is received. An association between the indicated predefined transaction participant role and a predefined master code is determined. Previously stored master data that is associated with the specified participant and with the associated predefined master code is retrieved, and the retrieved master data is used during the specified computer-implemented transaction involving the specified participant.

### TECHNICAL FIELD

This disclosure relates to defining and using relationships between stored master data and transactional data to process a business document.

### BACKGROUND

Users of computer system applications for processing transactions may frequently need to enter data into a document that describes the transaction. For example, a call center employee may receive calls from customers and may enter information into business documents (sales orders, service orders, etc.) based on dialogues with the customers. The user can, for example, manually type information into each field of the document. However, this may involve significant effort, may take a significant amount of time, and may force the user to remember or determine large amounts of information. In some cases, information to be entered in a transaction document may be repeated multiple times, whether in the same document or across more than one document.

One example of an online purchase order interface offered by a seller permits a user to store information, such as the user's name and address, so that each time the user creates a new purchase order to purchase an item from the seller using the interface, the user may identify himself or herself to the application and the application may provide the user's name and address in the purchase order. However, the user may be limited in that only purchase orders, and not other types of transaction documents, may be created. The user may additionally be limited in the number of information items that may be stored and recognized by the purchase order application. Further, a one-to-one relationship between the parties involved (that is, for a given user, the parties involved are always the same the buyer and the seller) may limit flexibility of the application.

### SUMMARY

This disclosure relates to defining and using relationships between stored master data and transactional data to process a business document.

In a first general aspect, a method includes receiving, for a specified participant, an indication of a predefined transaction participant role in which the specified participant serves in a specified computer-implemented transaction. The method also includes determining an association between the indicated predefined transaction participant role and a predefined master code. The method further includes retrieving previously stored master data that is associated with the specified participant and with the associated predefined master code, and using the retrieved master data during the specified computer-implemented transaction involving the specified participant.

In selected embodiments, multiple transaction participant roles may be defined for the specified transaction in a transaction processing module, and multiple master codes may be defined in a data module in which the master data is maintained and accessed by multiple different transaction processing modules. The predefined master code may be associated with two or more predefined transaction participant roles. Determining the association between the indicated predefined transaction participant role and the predefined master code may include accessing a system table of stored associations, or using one or more rules to determine the association.

In selected embodiments, using the retrieved master data during the specified computer-implemented transaction may include displaying the retrieved master data in one or more fields or screens associated with the transaction, comparing the retrieved master data to entered data associated with the transaction, restricting a query using the retrieved master data, or automatically adding the retrieved master data to a transaction document. The predefined master code may define a role or a relationship.

In a second general aspect, a computer program product tangibly embodied in an information carrier includes instructions that when executed by a processor perform a method to receive, for a specified participant, an indication of a predefined transaction participant role in which the specified participant serves in a specified computer-implemented transaction. An association between the indicated predefined transaction participant role and a predefined master code is determined. Previously stored master data that is associated with the specified participant and with the associated predefined master code is retrieved, and the retrieved master data is used during the specified computer-implemented transaction involving the specified participant.

In a third general aspect, a method includes defining a relationship between a predefined transactional role associated with a computer-implemented transaction and a predefined master code. The method also includes receiving an indication of the predefined transactional role and accessing the relationship using the received predefined transactional role to get the predefined master code. The method further includes using the predefined master code to access previously stored master data associated with the predefined master code for processing the computer-implemented transaction.

Advantages of the systems and techniques described herein may include any or all of the following: usability of business applications may be improved; business transaction processing functionality may be improved; users may save time and effort; users may enjoy a more user-friendly application interface experience; errors may be reduced; more complex associations may be defined; and flexibility in transaction processing may be enhanced.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an exemplary architecture that can be used to assign relationships between master data categories and transactional data categories.

FIG. 2 is a block diagram of an exemplary architecture that can be used to associate master data with transactional data.

FIG. 3 is a screen shot of an exemplary user interface that can receive transactional data associated with a transactional business document in the computing system of FIG. 1.

FIG. 4 is a screen shot of an exemplary user interface that can display a master data view associated with content in the interface of FIG. 3.

FIG. 5 is a screen shot of an exemplary user interface that can receive transactional data associated with another transactional document in the computing system of FIG. 1.

FIG. 6 is a screen shot of an exemplary user interface that can display a master data view associated with content in the interface of FIG. 5.

FIG. 7 is a screen shot of an exemplary user interface illustrating the use of value help information.

FIG. 8 is a flow chart of exemplary operations that can be performed by the architecture of FIG. 1.

FIG. 9 is a block diagram of a computing system that can be used in connection with computer-implemented methods described in this document.

Like reference symbols in the various drawings indicate like elements.

### DETAILED DESCRIPTION

This disclosure describes how system-defined relationships between master data categories and transactional data categories in a transactional business document may be used to define, verify, and perform various system or business tasks in an enterprise resource computing system. The tasks may include assisted or automatic data entry in the business document, data verification or checking of entered data in the document, document correction, determination of relevant business data, input assistance to a user, and others. In general, the relationship between the master data category and the transactional data category can be used or created to facilitate system or business processing tasks, which can make a user's job easier.

Master data information can describe data that remains consistent, in general, over a period of time, and may not typically be frequently altered, according to an implementation. In particular, master data may describe one or more properties of a business entity (e.g., a business partner, organization, etc.) independent of a particular transaction that the business entity may participate in or be involved with, or any role that the business entity may play in a transaction or in a corresponding document associated with the transaction. Master data may include business data relevant for business partners (e.g., customers, competitors, and vendors), products, services, shipping information, activities, and the like. For example, the master data information for a cost center may include the name of the cost center, the person responsible for the cost center, or the hierarchical location of the cost center within a business structure, to list just a few examples. As another example, the master data information for a vendor may include the name, address, and bank information for the vendor. Master data may also include roles or categories that describe one or more properties of the entity. A master data role or category for a business entity may describe a property of the entity that remains constant, in general. Examples of master data roles can include, without limitation, customer, supplier, employee, competitor, etc. Master data roles may be defined from the perspective of a home system, or from the perspective of a company or business operating a system, according to an implementation.

A given business entity may have more than one master data role or category. For example, a business partner can have the role of both a competitor and a supplier, for example. Suppose Company A and Company B are competitors in certain markets, but that Company A nevertheless purchases and uses certain of Company B's products (e.g., products in a market where A and B do not compete). In such a case, from Company A's point of view, Company B is both a competitor and a supplier. Continuing the example, if Company B similarly purchases products from Company A, then Company B may be viewed as a competitor, as a supplier, and also as a customer. Master data information may typically be stored and may be reused in multiple transactional business documents, which may alleviate a user from having to enter or re-enter information into a business document, potentially saving time, improving efficiency and minimizing entry error occurrences.

Master data can also include relationship data. For example, an employee (e.g., Jane Doe) can work for a business partner (e.g., Company Y). Here, an “employee” relationship may exist between the two since Jane Doe is an employee of Company Y. From Y's point of view, an “is an employee” relationship may be associated with entity Jane Doe. This relationship may generally remain stable over time, and thus it can be considered master data and may be stored as such. Further, both entities (Jane Doe, Company Y) can be categorized as business partners having an employee/employer relationship between them. Master data can further be partitioned into more than one type of master data. For example, a first class of master data may pertain to business partners external to a given company, while a second class of master data may pertain to organizational units within the company. Other classifications are possible. In various implementations, master data may be accessed or maintained by several different program applications or modules. In an implementation, a master data role or a master data relationship may be generally referred to as a master code.

Transactional business documents may be used to carry out the distribution of business functions and processes, and may be associated with business functions or processes. Examples of transactional business documents may include sales orders, purchase orders, manufacturing requests, service orders, contracts, and other business activities. Transactional business documents may include fields into which data may be entered. The data entered into business document fields may be considered transactional data, as the entered data may pertain to that particular document or transaction, in an implementation. Similarly, the fields of a transaction document may be associated with a transactional category or role, which may define a property of the field of the business document. In an implementation, data entered by a user into such a field in a transaction business document may be considered context information. In various implementations, context information, in addition to transactional data category information, may be used to improve the usability and/or performance of the system. For example, the system may use the transactional category to access a relationship between the transactional category and a master data category, which may have been previously defined by the system and may be stored in master data, for example, and may then use this master data category along with the context information to perform a system or business task. In an implementation, the information may be used to form an improved search query, which may advantageously result in narrowed and targeted search results. Such results can be used to auto-populate a field of the business document, for example, or to check against data entered by a user or computer system, as another example. In some cases, search results can be presented to a user, and the user may select one or more appropriate choices from the results, according to an implementation.

As will be described in more detail below, the system may use the transactional role category associated with a given field in a transactional document to access predefined relationships stored in master data that associate transactional data categories with master data categories. The system may use the predefined relationships to improve the usability and/or functionality of the system. In some implementations, these predefined relationships may be stored in one or more system tables of information, such as in a database table. In an implementation, the transactional category may serve as a key to the table. The system may search the table or tables using the key to find one or more related master data categories or roles, according to an implementation. When the relationship is accessed, for example, the located information can be used to improve system performance, such as by adding the information to a database query to enhance the query, which may result in improved search results, according to an implementation. This may enhance a usability experience for a system user, for example. In other implementation, the system may use a rule-based engine (not shown) that includes one or more rules to determine relationships between transactional data and master data, or between transactional data categories and master data categories.

Transactional data can also be categorized by roles describing the function of the transaction data. For example, a business partner having a master data role of customer (e.g., master data stored in the system having this role) may be described as having a transactional data role of product recipient in a particular transactional document, such as a sales order business document, or in a particular field, such as a “product recipient” field of the transactional document. As will be described below, stored master data information (e.g., address information, employee responsible information, team information, division information, or any other business information) for business partners with master data roles or master data relationships to other business partners or entities may be used in transactional documents, and the system may determine appropriate master data for such use based on system-defined relationships between the master data and transactional data or transactional data categories. In various implementations, a given transaction or transaction document may include multiple transactional roles defined for the transaction or the document, and these roles may be maintained in a transaction processing module, for example.

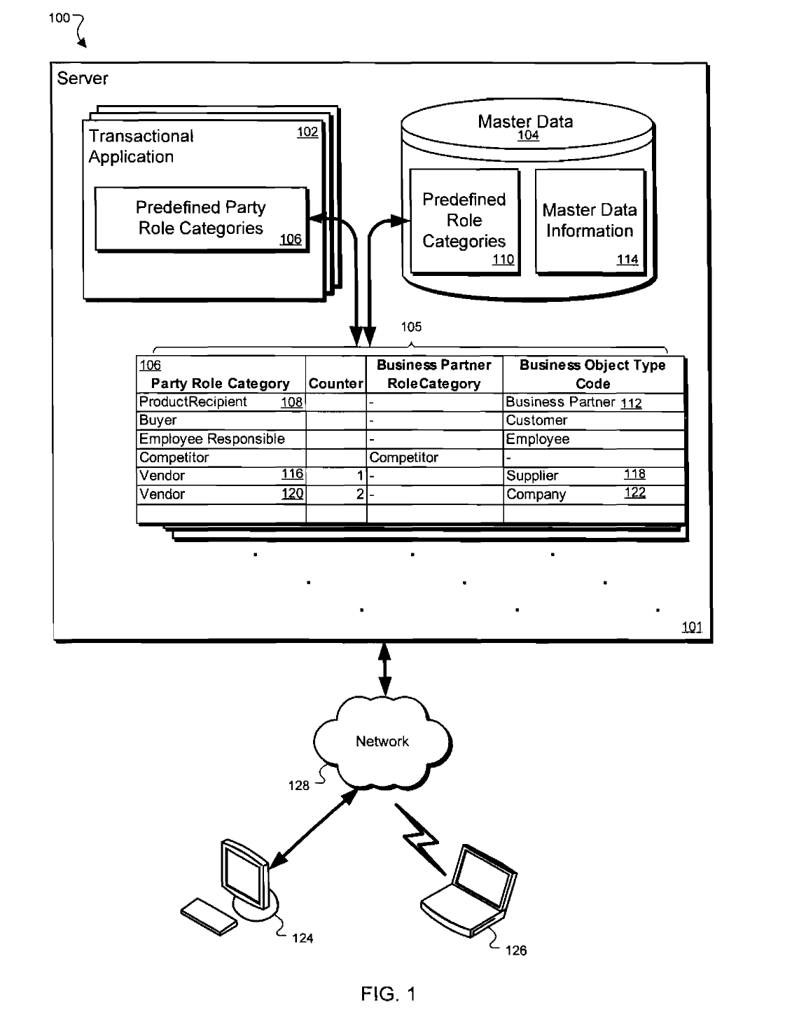

FIG. 1 is a block diagram of an exemplary architecture 100 that can be used to assign relationships between master data categories and transactional data categories. The one or more relationships can be evaluated to improve usability in one or more business documents, according to an implementation. For example, the relationships can be used to drive use of master data into business transactions, which can alleviate a user from having to manually enter the data in the business document. This may improve efficiency, save time, and reduce occurrences of errors caused by improper data entry. Further, in some implementations, the architecture 100 may facilitate the correction, definition, and/or entry of transactional or master data to populate business documents with data. This may provide similar benefits, including a robust operating environment for business applications.

Using the architecture shown in FIG. 1, a user (e.g., a call center agent) may enter business data into a business transaction document, such as a sales order, and the architecture 100 may assess the user-entered data to determine whether the data is included in the master data in the computing system 100, according to an implementation. For example, the architecture 100 may determine whether the entered data (e.g., a business partner) was previously entered (e.g., previously utilized as a supplier of goods) and stored as master data. Further, the architecture 100 may use the type of business transaction (a sale in this example, represented by the sales order) and the user-entered data (e.g., the business partner) to determine relevant master data for the business transaction. In some cases, the determined master data can be added to the business document; in other cases, the determined master data can be used to check aspects of the business document or data entered into the business document; in yet other cases the determined master data can be used in another business document or in another application, depending upon the implementation. For example, the architecture 100 can use the entered business partner information (which may be considered context information) along with an associated transactional business category or party role category corresponding to the field where the data was entered to determine address data and contact information or other information pertaining to the business partner. In some implementations, the type of business document may also be used by the system to access relevant master data for use in processing the business document.

The architecture 100 may use entered business data to determine which role the data will be assigned in a sales order transaction, according to an implementation. When creating a sales order corresponding to a sale to a particular business partner, the business partner may have various roles. For example, the business partner may be assigned the role of “sold-to,” “prospect,” “competitor,” “payer,” “goods recipient,” “employee responsible,” and others. In some implementations, the business partner may have multiple roles. For example, the business partner may be a customer (e.g., in a first transactional data role) as well as an employee responsible (e.g., in a second transactional data role) at the same time in various business transaction documents. In some implementations, the role may indicate to the architecture 100 which master data to access and provide to a user or to a transactional document. For example, if the business partner was assigned a “goods recipient” role, the architecture 100 may access and provide a “recipient” address for the selected business partner rather than an address, such as a “supplier” address, stored as a “supplier” role for the same business partner. In this fashion, the user may be spared the responsibility of entering or selecting frequently used master data (e.g., address, employee, contact, billing data, etc.) in a business document because the architecture 100 may determine the appropriate data. For example, the architecture 100 can determine the intended role for a selected business partner by utilizing master data stored in the system and the type of business document selected. In some implementations, automatic determination of an intended business partner role can prevent a user selection of erroneous of address information. As such, the architecture 100 may provide a user-friendly document entry interface, which can facilitate business transaction document entry.

In this description, the role that an entity plays in a transaction document or a field of the transaction document may be referred to as a “party role category.” For example, in a sales order, examples of party roles that a business partner may play can include buyer, product recipient, payer, bill-to party, contact person, or employee responsible, among others. The party can be described as a natural or legal person, organization, organizational unit, or group that is involved in a business document in a specific role. For example, a party included in a sales order transaction may be a business partner that has the specific party role category of “employee responsible” in a particular transaction document or field of the document.

In some implementations, the party role category “employee responsible” may not provide sufficient granularity for the business transaction document. For example, the company may wish to distinguish between a front office employee and a back office employee when assigning responsibility. As such, “party roles” (e.g., front office employee, back office employee) may be assigned under the party role category (e.g., buyer). In some implementations, a business partner may be assigned multiple party role categories in a transaction (e.g., both a buyer and a bill-to party). Thus, in an enterprise resource computing system, a party role category can generally make the process-relevant classification for the parties, while the party roles may represent the classification visible to the system user.

In some implementations, a similar principle can be applied to “business partner roles” and “business partner role categories” as they apply to master data. Here, a business partner may be considered to have a business object type, such as customer, supplier or employee, to list just a few examples. In some implementations, a refinement of the business object type may be desired, such as by defining roles or categories that offer finer granularity. For example, an entity having business object type “customer” may have role category of either “prospect,” which may indicate an entity that is not yet a true customer, “preferred customer,” which may indicate a high priority customer, and “general customer,” which may indicate a majority of paying customers, for example. Similarly, an entity having object type “supplier” may have refined role categories “bidder” or “vendor,” for example.

An enterprise resource computing system may refer to one or more software applications or software components used to execute a plurality of business processes in an organization (e.g., businesses, non-profit organizations, non-governmental organizations and governments). As one skilled in the art will appreciate, typical enterprise resource computing systems can include functions for performing at least one of enterprise resource planning (ERP), customer relationship management (CRM), supply chain management (SCM), human capital management (HCM), and supplier relationship management (SRM) processes.

Turning to the illustrated implementation, architecture 100 includes or is communicably coupled with server 101. Server 101 includes an electronic computing device operable to receive, transmit, process, and store data associated with architecture 100. Although FIG. 1 illustrates one server 101 that may be used with the disclosure, architecture 100 can be implemented using computers other than servers, as well as a server pool. Server 101 may be any computer or processing device such as, for example, a blade server, general-purpose personal computer (“PC”), Macintosh, workstation, Unix-based computer, or any other suitable device. The present disclosure contemplates computers other than general purpose computers as well as computers without conventional operating systems. Server 101 may be adapted to execute any operating system, including Linux, UNIX, Windows Server, or any other suitable operating system. According to one implementation, server 101 may also include or be communicably coupled with a web server and/or a mail server.

The architecture 100 also includes various applications, such as transactional software application 102. The transactional software application 102 can be hosted on server 101 to receive user input to complete a business transaction document, for example. In some implementations, the transactional software application 102 may be an enterprise resource software application. The application 102 may be used by a call center agent, an employee, or in some implementations, the application 102 can be used by a customer. As is conventional, the applications may be stored in a nonvolatile storage location, such as a data repository, including a data store exterior to the architecture 100, and may be transferred to memory for active use by the architecture 100.

The application 102 may be included in architecture 100 to create and maintain business documents and their associated relationships using master data 104. The application 102 may utilize various methods to create and/or maintain the consistency between master data 104 and transactional data, or between master data categories and transactional data categories. For example, the application 102 may use database tables having a particular schema to create and maintain the data and relationships. The schema may be organized as a relational model (e.g., as shown in FIG. 1 (105) in the form of one or more related tables, each consisting of rows and columns), a rule-based model, a hierarchical model, a network model, and others. In some implementations, multiple repositories can be utilized to create and/or maintain consistency between master data and one or more business documents.

The application 102 may include predefined party role (transactional data) categories 106. The transactional application may also include or have access to (as through interface with other application programs) one or more business transaction documents that can be used to represent or chronicle a business transaction. As described above, fields or aspects of a business document may be associated with a transactional category, or party role category 106. The predefined party role categories 106 may be used by the architecture 100 to access stored relationships with master data categories and for assigning master data to fields in the transaction application 102, which fields may be associated with the predefined party role categories 106. For example, an entry in a “product recipient” dropdown field in a sales order may be made by a user and the corresponding entry can be assigned the predefined party role category 106 of “product recipient” 108. This product recipient party role category 108 may be used to access a predefined relationship with a master data category, as defined by a business semantic maintained in master data 104. In operation, a specialized input field related to the party role category 108 (e.g., product recipient) may be included and selectable in the user interface. For example, table 105 shows that the product recipient party role category 108 is associated with a business partner role category 112, which appears in the record defined by the product recipient party role category 108. The business partner object type code may correspond to a master data category stored in predefined master data role categories 110 within master data 104. Here, the database table 105 shows the predefined role category 110 as “business partner” 112.

The master data repository 104, in this implementation, includes the aforementioned predefined role categories 110 and master data information 114. Master data information 114 may include business partner information stored as master data, which data may be accessed and used by the system for system or business tasks, including for processing business documents, according to an implementation. In general, data can be stored in master data information 114 with or without assigned predefined role categories 110. For example, a vendor that is regularly used in the system may be stored as master data information 114 along with a corresponding role category 110, one or more addresses, contact information, preferences, etc. In some implementations, a party role category 106 can be associated with multiple master data role categories 110, which can then be used to access different master data information 114. In this example, a first party role category associated with a field in a business document may be associated in the business semantic with a first master data category and corresponding information (e.g., an address stored in master data information 114). This is shown in the system table 105 where a first vendor party role category 116 (having counter “1”) may be associated with a “Supplier” master data category 118. The supplier master data category 118 may be maintained in the predefined role categories 110 of master data 104. The system may access this relationship, for example, when the user indicates a field in a purchase order corresponding to a transaction with the supplier, for example.

In addition, a second vendor party role category 120 (having counter “2”) may be associated with a “Company” master data category 122 in the system table 105. The company master data category 122 may similarly be maintained in the predefined role categories 110 of master data 104. As an example, a user may wish to find a particular vendor in the master data. To do so, the user may select “vendor” as the party role category in a business transaction document. The system may retrieve available resources in the categories of “supplier” or “company,” and may ignore items in the category “employee,” for example, because a vendor is generally not in the “employee” category. Thus, the system may restrict a query by using the relationship defined between the transactional data and the master data.

Returning to the illustrated architecture 100, the server 101 can generally store and use master data 104, and may transfer master data 104 to one or more client systems 124, 126, or another system, at least some of which can communicate across network 128. The server 101 may include local electronic storage capacity, such as master data repository 104. The data repository 104 may include any memory or database module and may take the form of volatile or non-volatile memory including, without limitation, magnetic media, optical media, random access memory (RAM), read-only memory (ROM), removable media, or any other suitable local or remote memory component. The illustrated data repository 104 may store system data such as predefined role categories 110, master data information 114, master data business object types, system tables defining relationships between transactional data categories and master data categories (e.g. table 105), virtual private network (VPN) applications or services, firewall policies, a security or access log, print or other reporting files, HTML files or templates, data classes or object interfaces, unillustrated software applications or sub-systems, and others.

The network 128 may facilitate wireless or wireline communication between the entities shown in FIG. 1, such as clients 124 and 126 or the server 101 hosting the architecture 100. The network 128 may be all or a portion of an enterprise or secured network. In another example, the network 128 may be a VPN between the server 101 and the client 124 across a wireline or a wireless link. While illustrated as a single or continuous network, the network 128 may be logically divided into various sub-nets or virtual networks without departing from the scope of this disclosure, so long as at least a portion of the network 128 may facilitate communications between the server 101 and at least one client (e.g., client 126). In certain implementations, the network 128 may be a secure network associated with the enterprise and certain local or remote clients 124 or 126. The network 128 may be the Internet, or a portion thereof.

The client 124 may be any computing device operable to connect or communicate with the server 101 or the network 128 using any communication link. At a high level, each client 124 may include or execute at least one hosted application graphical user interface. There may be any number of clients 124 communicably coupled to the server 101. As used in this disclosure, the client 124, 126 is intended to encompass a personal computer, touch screen terminal, workstation, network computer, kiosk, wireless data port, smart phone, PDA, one or more processors within these or other devices, or any other suitable processing device. For example, the client 124 may be a PDA operable to wirelessly connect with an external or unsecured network.

The transactional application 102 may be generally capable of assessing input, assigning a relationship based on the type of input, obtaining master data related to the input, and presenting the information in a business transaction document. In some implementations, the transactional application 102 may utilize user input to determine business data in the business transaction document. For example, if a “buyer” field were completed, the application 102 may use the information to automatically fill in other business partners, such as bill-to party, product recipient party, or payer party. In one implementation, the users of the application 102 may include sales personnel, customer service personnel, manufacturing personnel, field applications personnel, repair or installation personnel, or any other user of business information.

The exemplary screen shots that will be described below focus on the operation of the application 102, or one or more of its components or sub-modules, in performing one of the exemplary methods or processes. However, the architecture 100 can use any appropriate combination and arrangement of logical elements implementing some or all of the described functionality.

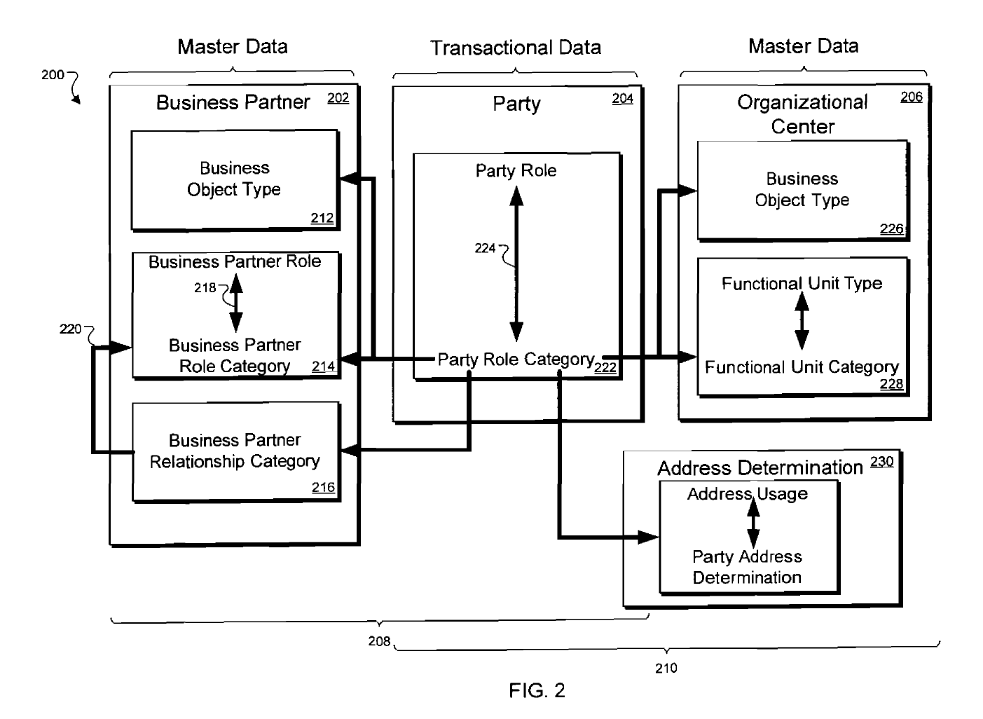

FIG. 2 is a block diagram of an exemplary architecture 200 that can be used to associate master data with transactional data. In general, an association may define relationships between business partners 202, parties 204, and organizational centers 206. As shown in FIG. 2, business partners 202 and organizational centers 206 may comprise master data, and in an implementation may be considered separate classes of master data. For example, business partner master data 202 may pertain to entities external to the business of reference, for example, while organization centers master data 206 may pertain to entities within the business of reference. A business partner may represent an individual within or outside of a particular organization who is of commercial interest and who can be contacted in the course of a business transaction, for example. Generally, the business partner can be a natural person, a legal entity, or a non-legal entity. Similarly, organizational centers 206 may represent a type of organizational entity found within a company, such as a subsidiary, division, department, or special project team. Parties 204, in contrast, may comprise transactional data or be defined by transactional categories or relationships, for example, which may indicate that such a role, category or relationship is relevant to a particular transaction or document, but perhaps not relevant outside of that context. Parties may represent business partners selected and assigned responsibility to roles represented in transactional business documents, for example.

As described above, a relationship or association can be defined between master data and transactional data, or alternatively, a relationship can be defined between master data and other master data or between transactional data and other transactional data. In addition, the relationships may be further differentiated by external 208 and internal 210 associations. For example, the business partner 202 may represent master data associated with an external entity or may be external master data that can be associated with the transactional data “party” 204. Similarly, the organization center 206 may represent master data associated with an internal entity or may be internal master data that can be associated with the transactional data “party” 204. Herein, business partner master data 202 will be referred to as “external master data” and organizational center master data 206 will be referred to as “internal master data” though both types of data may be stored and maintained internal to the system, including within a common or different data repository and within common system or database tables or in different tables, depending on the implementation.

External master data 202 can include object types, role data, and relationship data relevant to outside resources such as business partners (e.g., vendors, competitors, customers, suppliers, companies, etc.). Internal master data 206 can include object types and functional unit data relevant to inside resources and groups (e.g., sales units, purchasing units, sellers, etc.).

Referring to FIG. 2, the business partner 202 may play one or more roles in a transactional business document, which may be represented in FIG. 2 as party transactional data 204. In an implementation, the business partner 202 includes a business object type 212, a business partner role category 214, and a business partner relationship category 216. The business object type 212 may represent a high-level description of the business object, according to an implementation. Examples of business object types 212 may include customer, supplier, or employee. In general, the business object type 212 may describe characteristics and common attributes, including their methods, interfaces, and relationships for each instance of a business object (e.g., each business object instantiated in a transaction).

The business partner role category 214 may represent a refinement on the business object type 212, according to an implementation. In some cases, business partner role categories 214 may be defined with finer granularity than are the business object types 212. Examples of business partner role categories 214 may include prospect, preferred customer or general customer to correspond to an object type of customer, or bidder or vendor to correspond to an object type of supplier. In some implementations, business object type 212 and business partner role categories may be merged. In some implementations, the business partner role category 214 may be related to a business partner role, as indicated by arrow 218. A business partner role may include a separate description for the business partner and may comprise customized data that a user may define, such as to describe a business partner as desired, but which the system may not rely upon due to its potential for customization. In contrast, business object types 212 and business partner role categories 214 may typically be system-defined, according to an implementation. For example, a customer may assign two business partner roles (e.g., service recipient and goods recipient) to a business partner role category 214 product recipient, and the relationship may be defined by arrow 218. The business partner role category 214 may be used in the architecture 100 and 200 to determine which master data to use and/or display for the role. However, the business partner role can be used externally (e.g., at a customer site) to differentiate between two or more assigned business partner roles.

The business partner relationship category 216 may generally describe a characteristic of a relationship. A differentiation can be made between one-way business partner relationship categories (e.g., business partner 1 has a particular relationship with business partner 2, but not vice-versa), and between undirected relationship categories (a marriage, for example). The business partner relationship category 216 may indicate how the business partner role category 214 is assigned, as indicated by arrow 220. As an example, a relationship may be defined between two business partners. The business partners may include “Company X” and “Employee Y.” The relationship between the two business partners may be described as “Company X” has the employee “Employee Y.” Here, the business partner relationship is of category “has the employee.” Other examples for possible business partner relationship categories include, but are not limited to “has payer,” or “is product recipient of.”

Turning to the transactional data, the party 204 includes a party role category 222. The party role category 222 may represent the role that is assigned to a party within a particular business transaction document, or to a particular field, control, or aspect of a document. Examples of party role categories 222 can include a sold-to party, a bill-to party, a payer party, a ship-to party, etc. Typically, party role categories 222 may relate in some way to the type of business document in which they are being used. In some implementations, the party role category 222 may be related to a party role, as indicated by arrow 224. Party roles may be customizable by a user, in similar fashion as business partner roles may be customized, as described above. The party role 224 may include separate descriptions of several business objects belonging to the party role category 222. For example, a user may assign two party roles (e.g., front office employee and back office employee) to an employee responsible party role category 222, where the relationship is shown by arrow 224.

Referring now to the internal master data 206, relationships between internal master data and transactional data, or between internal master data categories and transactional master data categories may be defined in a business semantic in similar fashion as described above with respect to external master data. For example, business object types 226 may function similarly to business object types 212, functional unit categories 228 may function similarly to business partner role categories 214, and functional unit types may operate similarly to business partner roles, except that in each case they may pertain to entities within a reference business, such as a business using the systems and methods described in this disclosure, according to an implementation. Examples of functional unit categories 228 may include an organization within a business (e.g., administration, sales, marketing, production, etc.). Some organizations described by a functional unit category 228 may be accountable for one or more transaction types and/or associated documents. For example, the sales functional unit category may be accountable for all sales transactions occurring in the system.

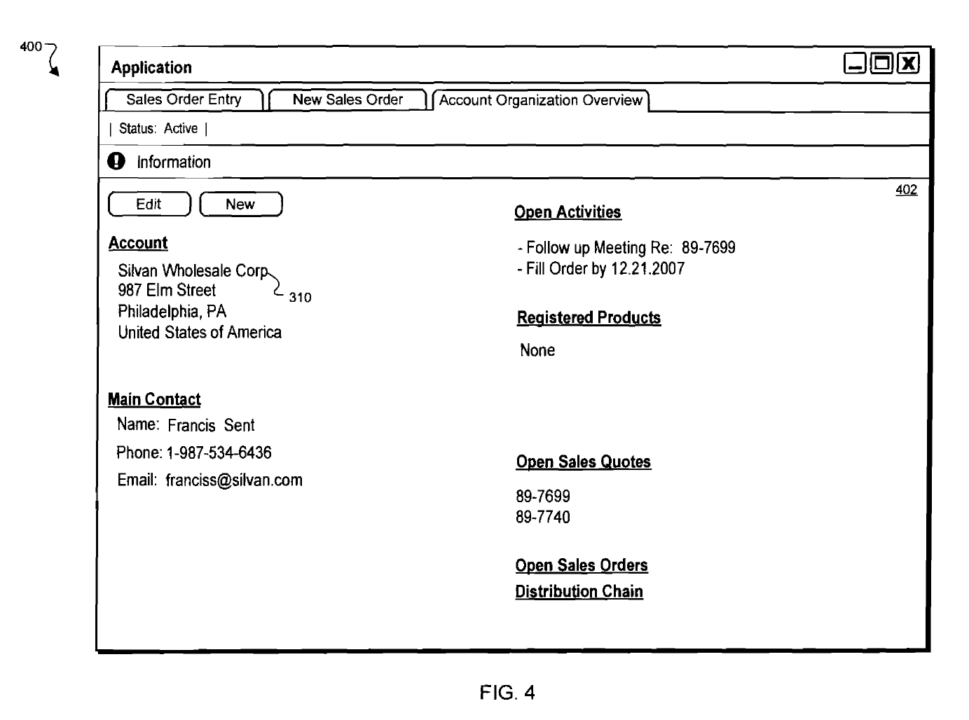

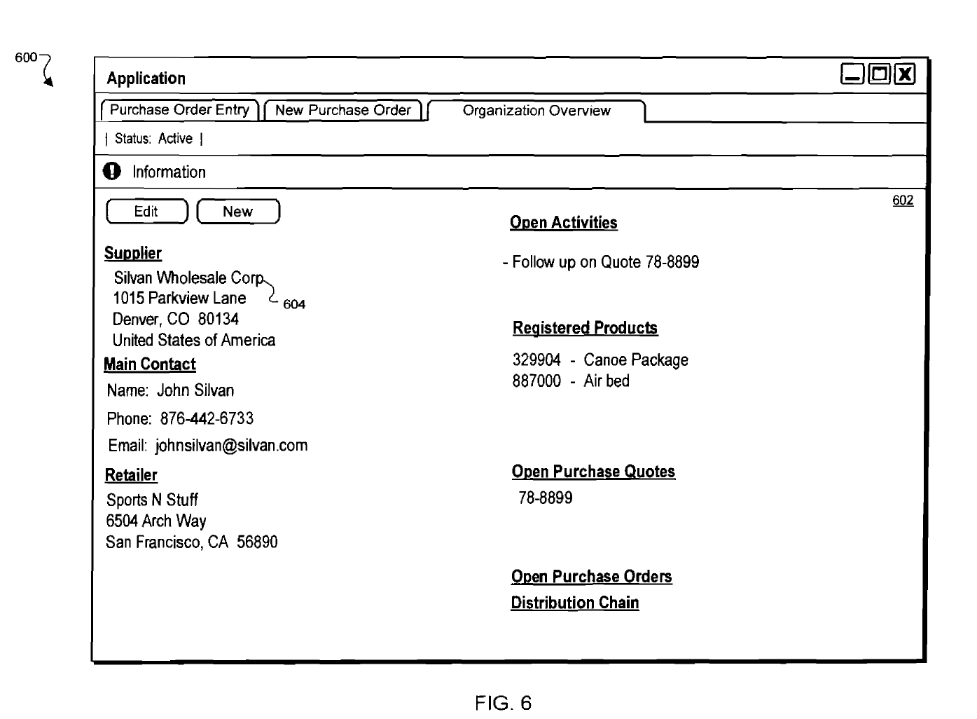

In operation, a transaction 210 involving an internal organization (e.g., a unit within the company) can be initiated using transactional application 102, as can a transaction 208 involving an external business partner (e.g., a supplier), for example. A user of the application 102 may create or initiate a transactional business document, such as a sales order or a purchase order. The orders may have fields for parties and other information to be entered, for example a ship-to party, a purchasing party, etc. The architecture may use a business semantic defined by relationships stored in system tables, for example, to use a party role category 222 to determine an associated business partner role category 214, functional unit category 228, business partner relationship category 216, or party address determination category, according to an implementation. For example, the user-entered value for the party role category can be automatically linked to the business partner role category 214 and any associated data (e.g., contact information, address, etc.) via a hyperlink, internal link, or other method. The link can be selected to navigate the user to the associated data, according to an implementation. For example, the sales order may include several parties (for example, business partners playing a particular role in a given transactional document) associated with various party role categories 222, such as a buyer, a payer, a bill-to, and a product recipient. If a user clicks on one of the parties, the system may jump to screens displaying master data associated with the business partner, according to an implementation. However, in some cases, multiple views may exist for a selected business partner. The architecture 100 can automatically navigate to the most relevant view for the selected party in the sales order transactional document using relationships between transactional categories and master categories, according to an implementation. The navigation to the best-suited view (display in a given business partner role category 214) can be determined by the predefined relationship between the party role category 222 and the business partner role category 214. Example views will be discussed with reference to FIG. 4 and FIG. 6 below.

In some implementations, the environment 200 can be used to determine address information for a particular party. For example, environment 200 can derive master data (e.g., party address information 230) to present to a user based on the party role category 222. The party role category 222 may be evaluated during transactional processing to determine the best suited address 230 from master data for use in the transaction. For example, Employee X may be an employee of Company Y, and Employee X may serve as the contact person for Company Y when dealing with an external business partner. In this example, suppose that Employee X has a work address in Wald, Germany, and a residential address in Heidelberg, Germany. When dealing with the external business partner, Employee X is playing the “party role” of contact person for Company Y, so the environment 200 may appropriately select the work address, as opposed to the residential address, when processing transactions involving Company Y and Employee X. As another example, a volume (e.g., a large volume of supplies) being delivered may indicate that a shipping address to a company's warehouse facility should be used, rather than a corporate address. Similarly, if a product is to be received, an association between a transactional category and a master category may permit the system to determine that a particular address should be used over another. Individuals or businesses, etc., may also be determined, in conjunction with the address determination or as a result of the address determination. For example, a manufacturing employee may be determined as the receiving party if the material requires inspection upon delivery.

In a similar fashion, the system may automatically determine an appropriate location among more than one possible location stored in master data. For example, a location appropriate for delivery, receipt or presentation of goods can be determined. Some companies may have a large facility with many entrances, such as an one or more employee entrances, a visitor entrance, a mail delivery entrance, a shipping entrance, a security entrance, and the like, even though the facility as a whole may have a single address. The system may determine that the shipping entrance is the most appropriate entrance when using the partner in a specific party role category in processing a transactional document and may automatically populate the document with the address, present the address to a user of the application, or use the address to check information in the document, for example.

For simplicity, FIG. 1 shows only business partner data (e.g., external master data), but may also include organizational center data (e.g., internal master data). For example, if organizational center data were included, FIG. 1 may include internal data within the master data repository 104 as well the possibility to select and use other types of transactional applications. Additionally, the system table or tables 105 may include relationships from party role categories to internal business object type codes 226 or functional unit categories 228. The system may then use these relationships to identify relevant master data, as by enhancing a search query for searching data, which may produce better search results, according to an implementation.

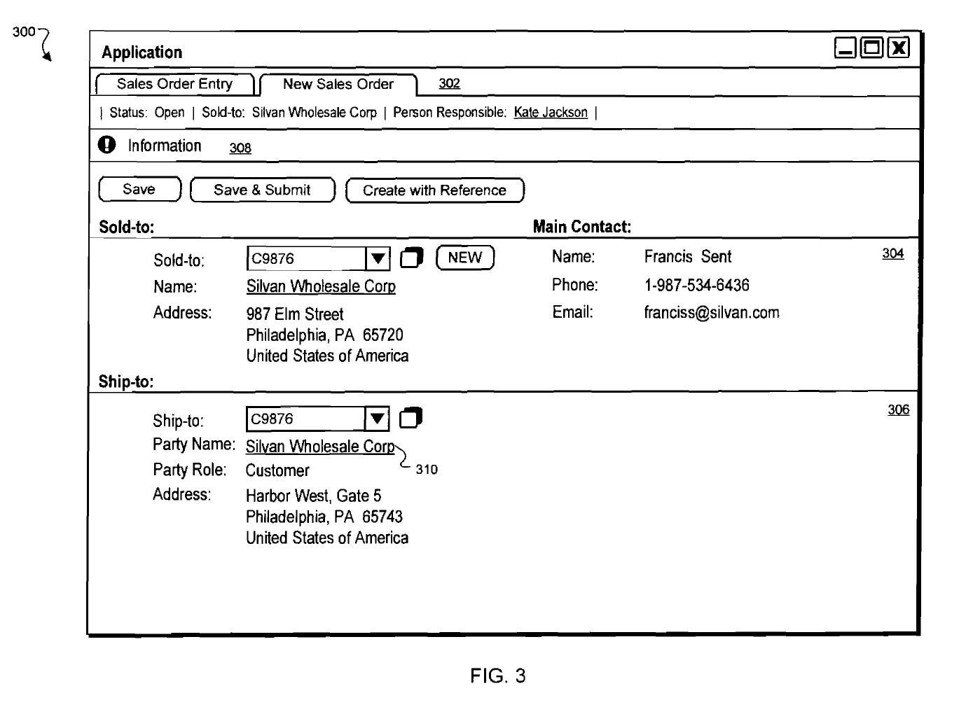

FIG. 3 is a screen shot of an exemplary user interface 300 that can receive transactional data associated with a transactional business document in the computing system of FIG. 1. The example interface shown in FIG. 3 depicts an exemplary sales order. The user interface 300 includes a tabbed menu 302 for creating transactions, a sold-to area 304 for entering business partner contact information, a ship-to area 306 for entering business partner shipping information, and an information area 308 where information or feedback can be provided. FIG. 3 is exemplary, and any number of display areas may be presented, and these display areas may be located at any appropriate place within the user interface.

The tabbed menu 302 may allow the system user the ability to quickly change views or transfer between open documents and other application modules. The sold-to area 304 and the ship-to area 306 can be manually modified or automatically modified. For example, the system 100 may automatically add data to the user interface 300. In addition, the areas 304, 306 can be minimized or maximized to provide an interface that is easily readable. This may provide advantages because the user may wish to view multiple ship-to addresses, for example.

The information area 308 may provide feedback to the user regarding entered data, updated data, completion of transactions, errors in transactions, and other system data. In some implementations, the user may select information details in the area 308 to be navigated to the indicated error. This may occur, in an implementation, if the error is within one of the open transactions, for example.

As shown in FIG. 3, the user has created a new sales order transaction and has filled-in the sold-to area 304 with party information (e.g., a customer number “C9876”). As described above, this field may have an associated party role category 108 (see FIG. 1) that may have a system-defined relationship to one or more certain master data categories. In this example, the party role may be “buyer,” since this is a sales order and the label on the field is “Sold-to.” The entered input (“C9876”) may be context information that can be used in conjunction with the information derived from the relationship to process the transaction. The system 100 can use the entered party information to automatically access and display additional information (e.g., previously stored master data) about the customer. In particular, the system 100 can automatically determine which master data information may be best suited for the type of transaction (e.g., a bill-to address for a sales order).

For example, the product recipient may generally remain the same each time a sale is made to a given company. The system 100 can use the relationship between this product recipient party and user-entered data (e.g., sold-to party) to automatically determine and/or populate the product recipient and the associated master data (e.g., ship-to address, payment methods, etc.). Thus, the relationship between the master data (e.g., previously stored information) and the entered transactional data (e.g., sold-to party) may be known by the system and used to automatically determine business parties, addresses, and contacts in transactions. In particular, the system 100 can use the user-entered “sold-to” information to derive the product recipient information via the predefined relationship of “has the product recipient.” In some implementations, the relationship between master data and transactional data can also be used to automatically populate several business transaction documents based on one or more field entries. The above auto-determination and auto-fill capabilities used by system 100 may provide the user with efficient usability of transactional business documents without having to understand, remember, or input some or all of the transaction data.

In some implementations, data presented in the user interface 300 may include a linking mechanism (e.g., a hyperlink) that, when selected, presents one or more screens of master data. For example, a more detailed description corresponding to the data shown with the hyperlink can be displayed to the user. In some implementations, selecting the hyperlink may present transactional data and master data. The system 100 can create a link to information in the master data repository 104, for example, that may pertain to the data in a transaction.

FIG. 4 is a screen shot of an exemplary user interface 400 that can display a master data view associated with content in the interface 300 of FIG. 3. In this example, the user has selected the link with the label “Silvan Wholesale Corp.” 310, which is shown in a “party name” field in the ship-to area 306 of interface 300. Based on the party role category of this field and a defined relationship between the category and a master category (which may be associated with particular master data information), the system may present a customer/account view 400 in response to the selection. While the system may store several views of information pertaining to Silvan Wholesale Corp., the system may present the most appropriate view, such as view 400, using context information and one or more associations between master data and transactional data. In one implementation, the selection of the link 310 initiates another instance of the application shown in user interface 400. In other implementations, the screen may be displayed as a pop-up screen, or side-bar item.

As shown, the master data view in interface 400 pertains to the “Silvan Wholesale Corp.” 310 from FIG. 3. In particular, the interface 400 shows previously stored master data associated (through the predefined relationship) with the transactional data role (e.g., sold-to party) in the sales order. The data shown in work area 402 includes various fields of information corresponding to the account, main contact, open activities, registered products and open sales quotes. It is possible to display more or less information in this view. Other types of information can also be shown.

Selection of one or more data hyperlinks can allow a user to quickly reference master data for various purposes. For example, the user may select a particular hyperlink to quickly view contact details (e.g., phone numbers, email, etc.) for purposes of contacting the selected contact. In one implementation, the master data may be viewed because the user has new information to enter into the master data screen.

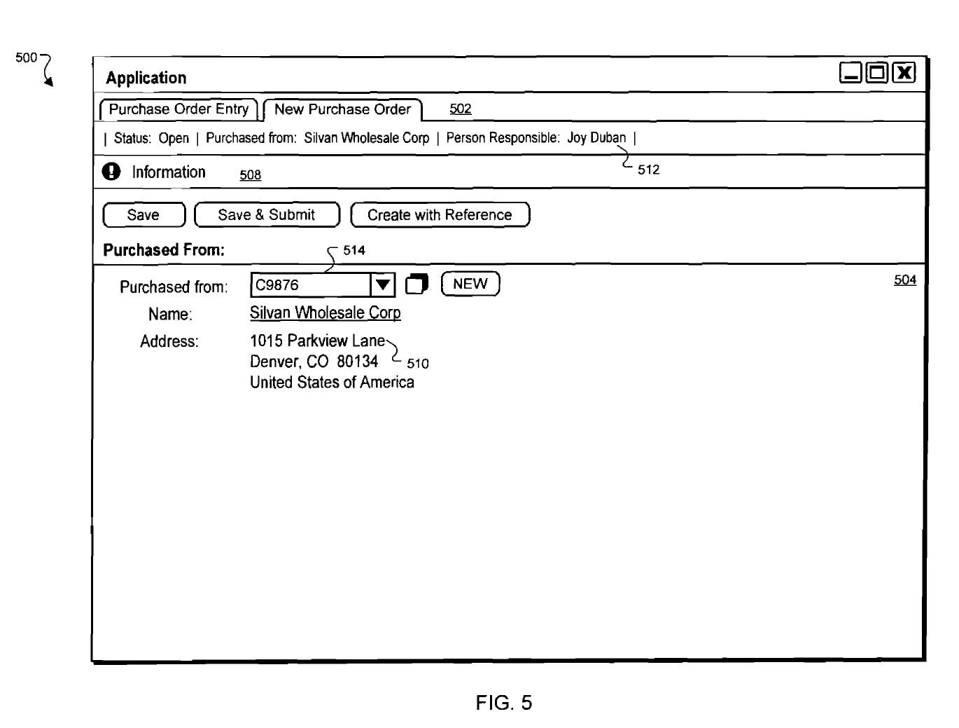

FIG. 5 is a screen shot of an exemplary user interface 500 that can receive transactional data associated with another transactional document in the computing system of FIG. 1. The user interface 500 is similar to user interface 300, but instead describes a purchase order transaction rather than a sales order transaction. The purchase order transaction may generally be performed for an organizational center (206). For example, items purchased for a company may belong to one or more organizational centers in the company (e.g., electrical parts may belong to engineering and/or manufacturing departments).

The user interface 500 includes a tabbed menu 502 for creating transactions, a purchased from 504 for entering business partner contact information and an information area 508 for providing information or feedback regarding user-entered data. FIG. 5 is exemplary, and any number of display areas may be presented, and these display areas may be located at any appropriate place within the user interface.

In this example, the party (e.g., business partner) is the same party from FIG. 3 above (“Silvan Wholesale Corp.”), but the party role for the associated field may have changed from a “buyer” party role in a sales order of FIG. 3 to a “seller” party role in the present purchase order. If a user selects the link defined by the “Silvan Wholesale Corp.” label in FIG. 5, the system may present a view with appropriate master data information, and the view may differ from the view presented in FIG. 4 (which was presented in response to a similar selection in interface 300 of FIG. 3). This will be described below with reference to FIG. 6.

The system may similarly use the party role of the entered business partner to determine which address for the business partner should be retrieved for the transaction. For example, a business partner may have three addresses (e.g., a ship-to address, a headquarters address, and a billing address). Since the party role is “seller” in this transaction, as described above, the address retrieved from master data in this case may be different than if the party role were “buyer.” This is shown in FIG. 5 as a different Silvan Wholesale Corp. address (“1015 Parkview Lane, etc.”) 510 than the address shown for Silvan in FIG. 3 (“987 μm Street, etc.”). In this example, the address 510 may correspond to an order reception address, for example.

FIG. 6 is a screen shot of an exemplary user interface 600 that can display a master data view associated with content in the interface 500 of FIG. 5. In this example, the user has selected the link with the label “Silvan Wholesale Corp.” from the interface 500 of FIG. 5. Based on the party role category of this field and a defined relationship between the category and a master category (which may be associated with particular master data information), the system may present the supplier view 600 in response to the selection. As such, interface 600 presents different information from interface 400, despite each being triggered by a selection of a link having the same label. This may be possible because of system recognition of associations between transactional data and master data categories, according to an implementation. In this fashion, the system may present the most appropriate view with the most relevant information using context information and one or more associations between master data and transactional data.

As shown, the master data view in interface 600 shows previously stored master data associated with the master data role (e.g., purchased-from party) in the purchase order. The data shown in work area 602 includes various fields of information corresponding to the supplier, main contact, retailer, open activities, registered products and open purchase quotes. It is possible to display more or less information in this view. Other types of information can also be shown. In some implementations, the content shown in the master data view 600 may be derived from the transactional party role of the selected link. For example, the purchased from contact link represents the “seller” party role and, as such, the presented master data pertains to the seller information for Silvan Wholesale Corp 604.

Referring again to FIG. 5, the system 100 can automatically verify or check entered information using a business semantic. For example, the system 100 may verify user-entered data by performing automated system checks on data in business transaction documents. As such, erroneous entries can be flagged or automatically corrected upon detection. Suppose, for example, that instead of the entered “Purchased From” entity “C9876,” the user instead entered “C8976.” In this case, the seller may not have the required master data (e.g., the relationship “is vendor”), and the system may recognize the error. As a further example, the entered person responsible, “Joy Duban” 512, may invoke an error if the selected seller 514 (“C9876” in this example) does not have an appropriate master data role. The error may be provided to the user in the information area 508, or in another area. The information message may include a suggested fix, or simply a notification including the error details. The system may use one or more relationships between transactional data and master data, or between master data, for example, to suggest a fix such as alternative master data information stored in the system, according to an implementation. In some implementations, upon receiving an error, the user may choose to accept the suggested fix, if one is available, or can modify the erroneous data manually. In some cases, the system can automatically correct the error.

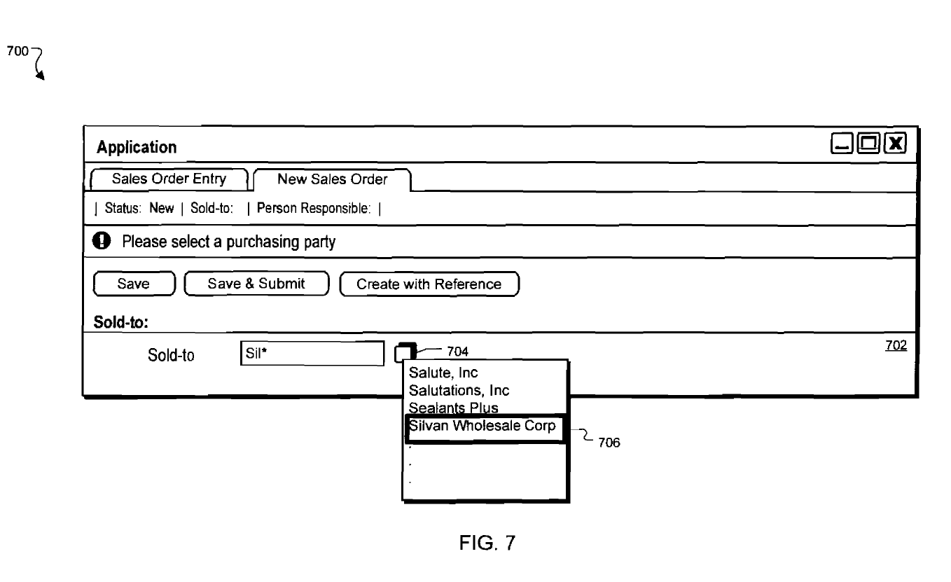

FIG. 7 is a screen shot of an exemplary user interface 700 illustrating the use of value help information. The interface 700 includes a sold-to area 702 for entering business partner contact information and a value help icon 704 that can be selected or accessed for help in entering business partner information. The value help can generally be used to filter a search such that it narrows the options according to relevancy. For example, the value help can use a relationship between master data and transactional data to narrow the number of options presented according to the predefined relationship. As another example, if the user is searching for a buyer, then the selectable options can be narrowed to include only master data information associated with master data category “customer,” for example, rather than including master data information associated with other categories as well.

In some implementations, a user can enter some or all of a business partner information, with or without a wildcard symbol (e.g., “*”) to receive a pop-up 706 of narrowed and relevant entries. That is, the value help pop-up can include selectable values having the entered text and included in the selected party role. In this example, the selected party role may be “sold-to,” as indicated by the label associated with the field for which the value help is offered.

In some implementations, the icon 704 may be hovered-on or selected to provide a user with further information about the field. For example, the user may use a pointing device to hover over the icon 704, as by positioning a cursor over the icon 704 using a mouse, for example, to view a list of business partners, contacts, or addresses selectable for the transaction. Value help icons 704 may display on any, all, or none of the selectable fields in the application. In some implementations, value help icons 704 may be enabled and disabled as configured by the user. The value help menu may include several selectable values dependent on the attribute selected. In this example, the value help menu may include various other business partners a sales order may select from. This may provide a convenient way for a user to select a desired value amongst a list or table of values or options, and the most relevant options may be presented based on the business semantic system relationships described herein. While this example shows a value help icon 704, a drop-down list indicator may function similarly, and the system may use relationships to present relevant and appropriate choices in a similar fashion.

In some implementations, the value help may use the business object type to determine the population of data in the list. In general, the architecture 100 can be used to narrow a field search to include the best suited information to facilitate user entry. For example, if a user has partially filled in the sold-to area 702, then the value help may suggest the possible “sold-to” companies in the system. As shown in FIG. 7, the value help may suggest “Silvan Wholesale Corp,” but not “John Silvan,” since “John Silvan” is generally considered a contact rather than a sold-to company. This may indicate that the system uses relationship knowledge between a party role (e.g., buyer) and a master data role (e.g., customer). As another example, the user can enter partial information into a “seller” field instead of a “sold-to” field. Here, the user may similarly enter “sil*,” but this time the system may interpret the data and present only supplier parties in the value help control 704 since the user entered data in the “seller” field.

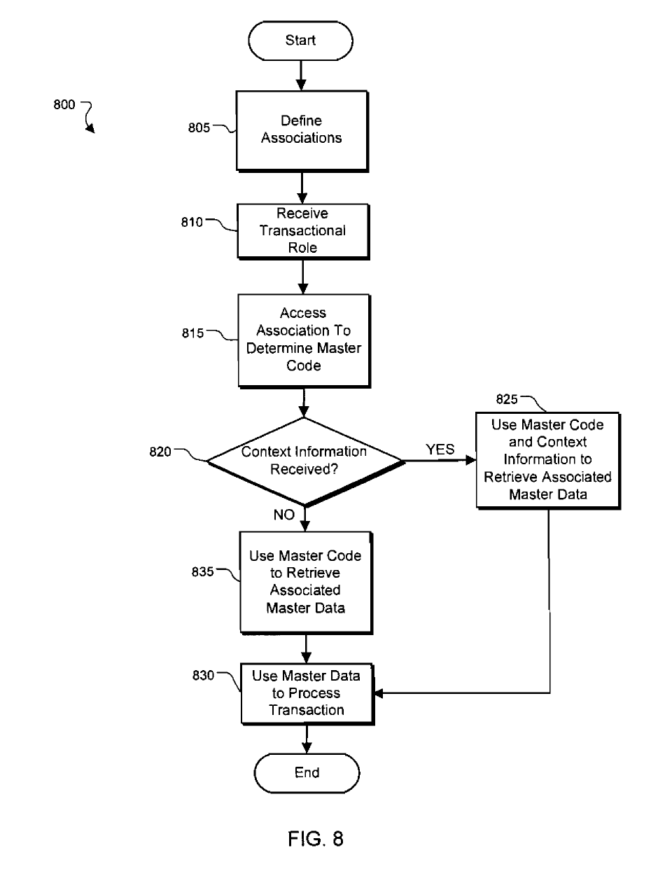

FIG. 8 is a flow chart of exemplary operations that can be performed by the architecture 100 of FIG. 1. A process begins at step 805 with a definition of one or more associations. The one or more associations may define relationships between a transactional role and a master role, or a transactional role category and a master role category, for example. The relationships may comprise a business semantic that can be used for transaction processing, according to an implementation. The associations may be stored in system tables, and in an implementation the transaction role may serve as a key to the table and the master role may be a dependent field in the record defined by the transaction role.

An indication of a transaction role is received at step 810. The transaction role may be received, for example, in connection with a user selection of a field, control, or interface aspect associated with the transaction role within a transaction document. The association may be accessed using the received transaction role to determine the associated master code at step 815. A master code may be a role code (e.g., a master data role) or a relationship code in various implementations. If context information, such as an indication of a transaction participant, is received at step 820, the master code and the context information may be used to retrieve associated master data at step 825, and the master data may be used to process the transaction at step 830 and the process ends. If context information is not received at step 820, the master code may be used to retrieve associated master data at step 835, and the master data may be used to process the transaction at step 830 and the process ends. Master data may be retrieved at step 835, according to an implementation, by forming a query using the determined master code (e.g., a role or a relationship, determined in step 815) and searching a database of master data information. Similarly, data may be retrieved at step 825, according to an implementation, by forming a query using the determined master code (e.g., a role or a relationship, determined in step 815) and the received context information and searching a database of master data information.

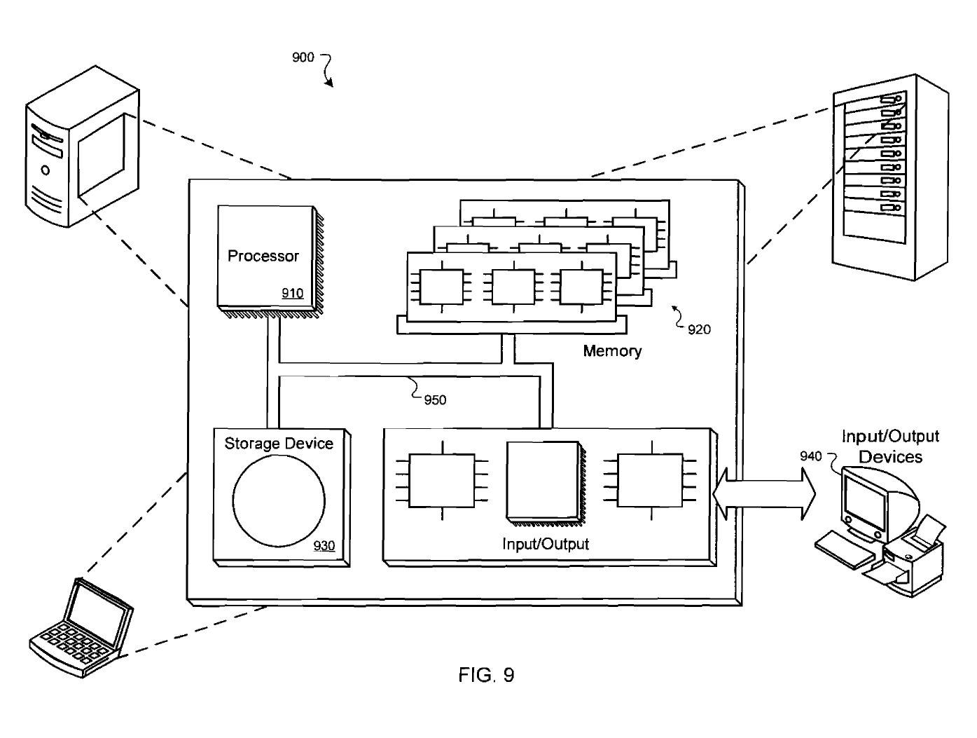

FIG. 9 is a schematic diagram of a generic computer system 900. The system 900 can be used for the operations described in association with any of the computer-implement methods described previously, according to one implementation. The system 900 includes a processor 910, a memory 920, a storage device 930, and an input/output device 940. Each of the components 910, 920, 930, and 940 are interconnected using a system bus 950. The processor 910 is capable of processing instructions for execution within the system 900. In one implementation, the processor 910 is a single-threaded processor. In another implementation, the processor 910 is a multi-threaded processor. The processor 910 is capable of processing instructions stored in the memory 920 or on the storage device 930 to display graphical information for a user interface on the input/output device 940.

The memory 920 stores information within the system 900. In one implementation, the memory 920 is a computer-readable medium. In one implementation, the memory 920 is a volatile memory unit. In another implementation, the memory 920 is a non-volatile memory unit.

The storage device 930 is capable of providing mass storage for the system 900. In one implementation, the storage device 930 is a computer-readable medium. In various different implementations, the storage device 930 may be a floppy disk device, a hard disk device, an optical disk device, or a tape device.

The input/output device 940 provides input/output operations for the system 900. In one implementation, the input/output device 940 includes a keyboard and/or pointing device. In another implementation, the input/output device 940 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A computer-implemented method of using participant information in transaction processing, the method comprising:
receiving, for a specified participant, an indication of a predefined transaction participant role in which the specified participant serves in a specified computer-implemented transaction;
determining an association between the indicated predefined transaction participant role and a predefined master code;
retrieving previously stored master data that is associated with the specified 9 participant and with the associated predefined master code; and
using the retrieved master data during the specified computer-implemented transaction involving the specified participant.

2. The computer-implemented method of claim 1, wherein multiple transaction participant roles are defined for the specified transaction in a transaction processing module.

3. The computer-implemented method of claim 1, wherein multiple master codes are defined in a data module in which the master data is maintained and accessed by multiple different transaction processing modules.

4. The computer-implemented method of claim 1, wherein the predefined master code is associated with two or more predefined transaction participant roles.

5. The computer-implemented method of claim 1, wherein determining the association between the indicated predefined transaction participant role and the predefined master code comprises accessing a system table of stored associations.

6. The computer-implemented method of claim 1, wherein determining the association between the indicated predefined transaction participant role and the predefined master code comprises using one or more rules to determine the association.

7. The computer-implemented method of claim 1, wherein using the retrieved master data during the specified computer-implemented transaction comprises displaying the retrieved master data in one or more fields or screens associated with the transaction.

8. The computer-implemented method of claim 1, wherein using the retrieved master data during the specified computer-implemented transaction comprises comparing the retrieved master data to entered data associated with the transaction.

9. The computer-implemented method of claim 1, wherein using the retrieved master data during the specified computer-implemented transaction comprises restricting a query using the retrieved master data.

10. The computer-implemented method of claim 1, wherein using the retrieved master data during the specified computer-implemented transaction comprises automatically adding the retrieved master data to a transaction document.

11. The computer-implemented method of claim 1, wherein the predefined master code defines a role.

12. The computer-implemented method of claim 1, wherein the predefined master code defines a relationship.

13. A computer program product tangibly embodied in an information carrier and comprising instructions that when executed by a processor perform a method for using participant information in transaction processing, the method comprising:
receive, for a specified participant, an indication of a predefined transaction participant role in which the specified participant serves in a specified computer-implemented transaction;
determine an association between the indicated predefined transaction participant role and a predefined master code;
retrieve previously stored master data that is associated with the specified participant and with the associated predefined master code; and
use the retrieved master data during the specified computer-implemented transaction involving the specified participant.

14. The computer program product of claim 13, wherein multiple transaction participant roles are defined for the specified transaction in a transaction processing module.

15. The computer program product of claim 13, wherein multiple master codes are defined in a data module in which the master data is maintained and accessed by multiple different transaction processing modules.

16. The computer program product of claim 13, wherein the predefined master code is associated with two or more predefined transaction participant roles.

17. The computer program product of claim 13, wherein determining the association between the indicated predefined transaction participant role and the predefined master code comprises accessing a system table of stored associations.

18. The computer program product of claim 13, wherein using the retrieved master data during the specified computer-implemented transaction comprises displaying the retrieved master data in one or more fields associated with the transaction.

19. The computer program product of claim 13, wherein using the retrieved master data during the specified computer-implemented transaction comprises comparing the retrieved master data to entered data associated with the transaction.

20. A computer-implemented method of using master data in transaction processing, the method comprising:
defining a relationship between a predefined transactional role associated with a computer-implemented transaction and a predefined master code;
receiving an indication of the predefined transactional role and accessing the relationship using the received predefined transactional role to get the predefined master code; and
using the predefined master code to access previously stored master data associated with the predefined master code for processing the computer-implemented transaction.
